(19) United States
(12) Patent Application Publication
(10) Pub. No.: US 2025/0066230 A1
(43) Pub. Date: Feb. 27, 2025

(54) VENTURI DESIGN AND SYSTEM EMPLOYING SUCH FOR DOSING USE IN WATER TREATMENT

(71) Applicant: MAYTRONICS AUSTRALIA PTY LTD, Oxley (AU)

(72) Inventor: William SMITH, Oxley (AU)

(21) Appl. No.: 18/727,351

(22) PCT Filed: Jan. 10, 2023
(86) PCT No.: PCT/AU2023/050009

§ 371 Date: Jul. 9, 2024

(30) Foreign Application Priority Data
Jan. 10, 2022 (AU) 2022900043

(51) Int. Cl. C02F 1/68; B01D 53/22; B01F 23/2326; B01F 23/237; B01F 25/312; B01F 101/00; C02F 1/461; C02F 1/467; C02F 1/78; C02F 103/42; E04H 4/12

(52) U.S. Cl. CPC C02F 1/685; B01D 53/229; B01F 23/2326; B01F 23/237613; B01F 25/312532; B01F 25/312533; C02F 1/46104; C02F 1/4674; C02F 1/78; E04H 4/1209; B01D 2256/12; B01D 2257/102; B01F 2101/305; C02F 2103/42; C02F 2201/007; C02F 2201/782; C02F 2209/02; C02F 2209/06; C02F 2303/04

(57) ABSTRACT

The present invention relates to a delivery system. In particular, the invention relates to a system for delivery of one or more products to a body of water for treating and/or disinfecting the body of water. The invention further relates to methods of using a delivery system of the invention for delivery of one or more products to a body of water for treating and/or disinfecting the body of water. Even more particularly, the invention relates to a system for delivery of ozone and/or chlorine to a swimming pool or spa for disinfection of pool or spa water.

### TECHNICAL FIELD

The present invention relates to a delivery system. In particular, the invention relates to a system for delivery of one or more products to a body of water for treating and/or disinfecting the body of water. The invention further relates to methods of using a delivery system of the invention for delivery of one or more products to a body of water for treating and/or disinfecting the body of water. Even more particularly, the invention relates to a delivery system for delivery of ozone and/or chlorine to a swimming pool or spa for disinfection of pool or spa water, although the scope of the invention is not necessarily limited thereto.

### BACKGROUND ART

There are numerous methods for treatment of water, whether the water is for drinking, bathing or swimming. Traditionally, chlorine has been used to disinfect water, and with particular reference to swimming pools, has been used in the form of chlorine gas or hypochlorite. Once chlorine gas or hypochlorite contacts water, hypochlorous acid, the active sanitizing agent, is produced. Advantages associated with using chlorine, particularly with regards to treatment of swimming pool water, include that it is rapid-acting, has a relatively long-lasting effect, acts as an algaecide and oxidizes contaminants. This type of chlorination can be used to kill bacteria, viruses and other microbes.

To avoid chlorine-based products, which can be expensive, irritating to eyes and nasal passages, and also caustic or acidic to handle, there has been a move towards salt water chlorination. A chloride salt, such as sodium chloride, is subjected to electrolysis to produce hypochlorous ions, which react with water to produce hypochlorous acid and free chlorine. Although chlorine gas, hypochlorite, and hypochlorous acid are produced, similarly as for a traditional chlorinated swimming pool, the use of a chloride salt presents less hazards with regards to handling, and eye and nasal irritation. The use of chloride salts as the source of chlorine is also a cheaper option, as salt is significantly cheaper than other sources of chlorine used for pools.

In a further, more recent development in the treating of swimming pool water, ozone has become increasingly popular. Ozone has proved popular for swimming pool treatment because it is more effective than chlorine, is not as harsh on skin, and doesn't generate fumes, which are present when using traditional chlorination methods.

Although ozone is a gas, it is not transportable, so rather than being able to purchase, for example a gas cylinder of ozone, it is generated in situ. With a particular focus on generation of ozone for use in treating swimming pools and spas, ozone can be generated using an ozone generator, also known as an ozonator.

The two main methods for generating ozone for use in swimming pools and spas are (i) a corona discharge ozonator; and (ii) an ultraviolet (UV) ozonator. A corona discharge ozonator uses high voltage electrical discharges to generate ozone from oxygen in air, whilst for a UV ozonator, air is passed over a UV lamp that emits light at a particular UV wavelength.

Once the ozone is generated, irrespective of the method used, the ozone is then passed into the body of water, for example, a swimming pool or spa, where it dissolves in the water and acts to treat or disinfect the water.

A particular disadvantage of ozone is its perceived relatively short life-span. It is commonly thought that ozone decays in water, however, there are a variety of factors that influence the life-span, stability and/or solubility of ozone in water. Such factors include the concentration of ozone, the pH of the water, temperature, and other compounds present in the water.

Increasing the amount of ozone is one avenue for increasing the effectiveness of ozone in treating a body of water. Although this could be achieved by simply increasing the amount of ozone generated, it would be advantageous to have a method of increasing the solubility of generated ozone in water, without having to simply generate more ozone. In any case, simply generating more ozone would likely lead to simply losing more ozone from the body of water to the atmosphere, rather than retaining the extra ozone in the body of water.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a system for delivery of one or more products to a body of water for treating and/or disinfecting the body of water, which may at least partially overcome at least one of the abovementioned disadvantages or provide the consumer with a useful or commercial choice.

With the foregoing in view, the present invention in one form, resides broadly in a system for delivery of one or more products to a body of water for treating and/or disinfecting the body of water, the system comprising:
(i) a water inlet;
(ii) an ozonator;
(iii) a venturi;
(iv) an electrolyser; and
(v) a water outlet,
   wherein the ozonator is in gaseous communication with the venturi, such that ozone generated in the ozonator is introduced into water as it passes from the inlet into the venturi, wherein a stream of water simultaneously passes through the electrolyser, and wherein the resultant ozonated water and electrolysed water combine to form a single streat that exits the system via the water outlet.

In another form, the invention provides a method of treating and/or disinfecting a body of water, the method comprising passing a portion of the water through a system, the system comprising:
(i) a water inlet;
(ii) an ozonator;
(iii) a venturi; and
(iv) a water outlet,
   wherein the ozonator is in gaseous communication with the venturi, such that the portion of water enters the system via the water inlet and passes through the venturi, while ozone generated in the ozonator is introduced into the water as it passes through the venturi, resulting in ozonated water which exits the delivery system via the water outlet.

The delivery system can further comprise an electrolysis cell for additionally generating hypochlorous acid from salt dissolved in the portion of water. The system can thus not only provide ozone for treatment of the water but simultaneously make use of chlorine for treatment of the water.

The ozonator can be a corona discharge ozonator or a UV ozonator. Corona discharge ozonators are advantageous as they can produce large quantities of ozone, are more cost-effective than UV-ozonators, and the coronal cell has a longer life than a UV lamp. Therefore, in a preferred embodiment, the ozonator is a corona discharge ozonator.

Preferably, the venturi is associated with a chamber at the outlet of the venturi, effectively a stagnation chamber, in which the velocity of the water which has passed through the venturi is effectively zero (or at least very low), with concomitant high static pressure. The high static pressure results in an increase in the solubility of gases in the water. Positioning the stagnation chamber at the outlet of the venturi, after the ozone has been introduced into the water as it passes through the venturi, specifically provides for an increase in the solubility of ozone in the water in the stagnation chamber. The ozonated water then passes from the stagnation chamber through the water outlet into the main body of water.

Even more preferably, the venturi has a large diameter outlet with internal radial vanes. The internal radial vanes effectively reduce the hydraulic diameter of the venturi outlet, leading to laminar flow of the ozonated water stream and hence pressure recovery of the ozonated water stream.

Thus, the present inventors have found that by adjusting the velocity and/or static pressure of water into which the generated ozone is passed, the level of ozone in the water can be increased, effectively increasingly the solubility of ozone in the water.

As such, in a further form, the invention provides a device for increasing static pressure in a fluid, thereby increasing ozone solubility in the fluid. The invention also provides a method of increasing ozone solubility in a fluid, by increasing the static pressure of the fluid.

In a particularly preferred embodiment, the water inlet is spacially distant from the water outlet. Distancing the water outlet from the water inlet maximizes the flow of water through the venturi, and therefor also contributes to maximizing the amount of ozone dissolved in the water.

Optionally, the delivery system can further comprise an oxygen separator membrane. Without wishing to be bound by theory, the inventors believe that use of an oxygen separator membrane reduces the amount of bubbles in the water as it passes into the venturi, thereby reducing the amount of oxygen in the water, and increasing the capacity of the water to dissolve generated ozone.

Preferably, the oxygen separator membrane is associated with the venturi, such that the oxygen separator membrane and the venturi act cooperatively.

In a particularly preferred embodiment, the oxygen separator membrane is attached to an air inlet of the corona discharge ozonator. The oxygen separator membrane effectively prevents passage of some nitrogen, thus reducing the total amount of gas, and concentrating the oxygen content to allow for more ozone.

In a preferred embodiment, ozone gas is introduced via a flow parallel to the electrolyser. The ozone stream water is compressed thereby dissolving the ozone prior to mixing the ozone stream water with the electrolyser stream water. As a result, the ozone is dissolved before any competing gases from the electrolyser are introduced.

The electrolyser can be fitted with an electrode identification dongle. Preferably, the dongle is not directly connected to a power source. Instead, it is preferred that the dongle obtain power via a pair of bipolar electrodes associated with the electrolyser. The voltage is induced into these electrodes rather than directly connected. In a unique arrangement, a voltage drop between the electrodes results in an induced voltage that powers the dongle. The dongle connection to the electrodes can be via a metal strap which is compatible with spotwelding to the electrodes. The strap can be nickel plated or other solder compatible metal so that it can be soldered to the circuit board. The dongle can then be encapsulated in a waterproof and corrosion resistant polymer and housed within the wet part of the electrode casing.

The positioning of the dongle in this manner enables identification of cell type (specifically, the cell type based on VA rating) such that the output power of the electrolyser can be automatically configured. The dongle can also provide an indication of electrode health in relation to signal strength.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a side view of a delivery system according to an embodiment of the invention;

FIG. 2 is a top perspective view of the embodiment of FIG. 1;

FIG. 3 is a top left perspective view of a delivery system according to an alternative embodiment of the invention;

FIG. 4 is a top right perspective view of the embodiment of FIG. 3;

FIG. 5 is a front left perspective view of the embodiment of FIG. 3;

FIG. 6 is a top left perspective view of an embodiment of a control box according to an embodiment of the invention;

FIG. 7 is a top right perspective view of the embodiment of FIG. 6;

FIG. 8 is a perspective view of an ozone corona discharge encapsulation assembly as part of an embodiment of the invention; and

FIG. 9 is a perspective view of an outer case for the ozone corona discharge encapsulation assembly of FIG. 8.

### DESCRIPTION OF EMBODIMENTS

In FIG. 1, there is shown a side view of a delivery system 10 according to an embodiment of the invention. The delivery system 10 has a water inlet 12 through which a portion of a body of water for treating enters the system 10. The water passes from the inlet 12 through a flow splitter 14. The flow splitter 14 enables some of the portion of water to continue to a venturi 16 and some of the portion of water to pass to an electrolyser 18.

The venturi 16 is provided with an ozone inlet port 20, through which ozone from an ozonator (not shown) is introduced to the venturi 16, and thus the portion of water that is passing through the venturi 16.

After passage through the venturi 16, the ozonated water enters a stagnation chamber 22 at the outlet of the venturi 16. The ozonated water then passes from the stagnation chamber 22 through a water outlet 24 into the main body of water.

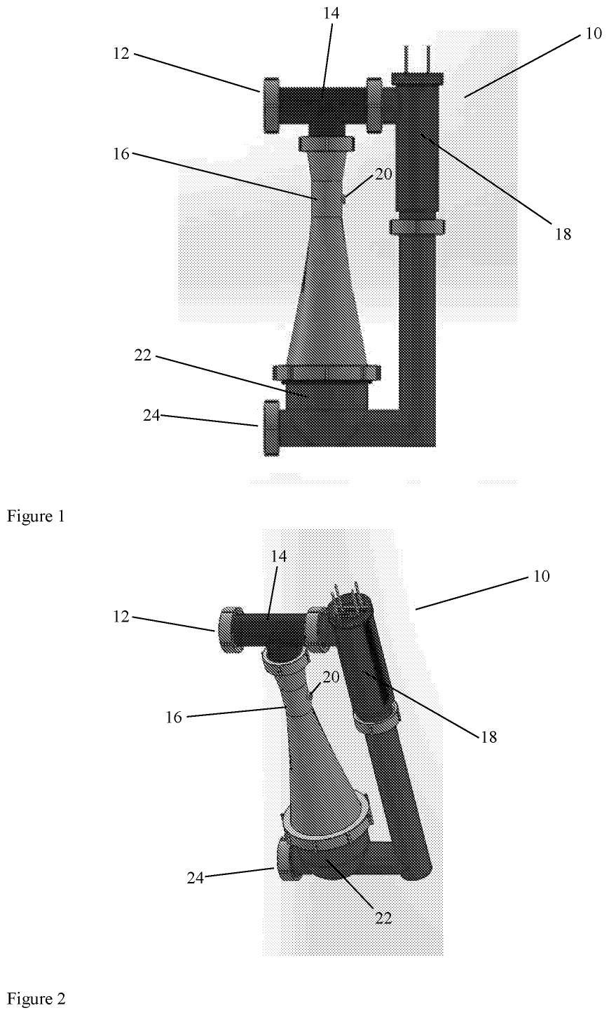

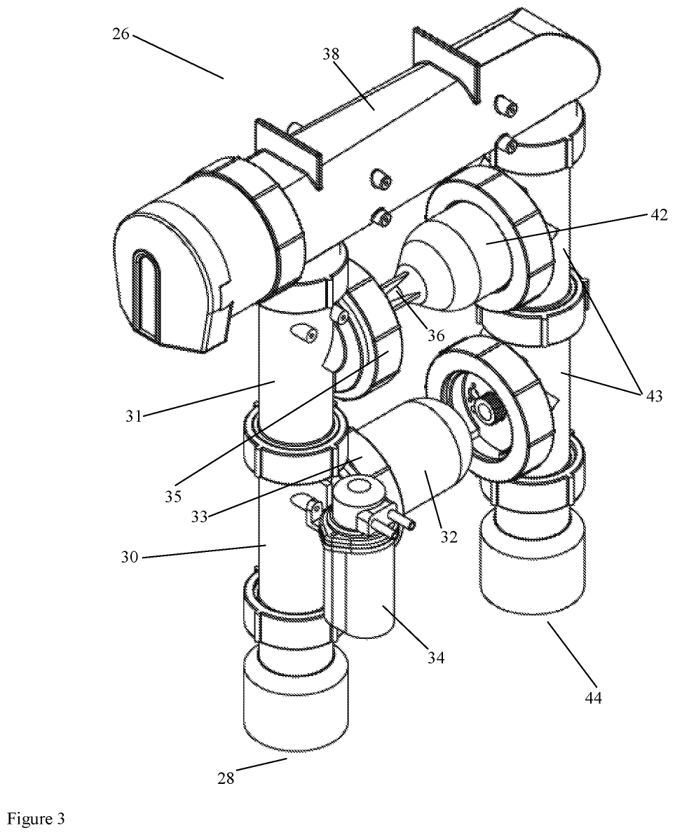

In FIG. 2, a top perspective view of the delivery system of FIG. 1 is shown, with like features numbered similarly.

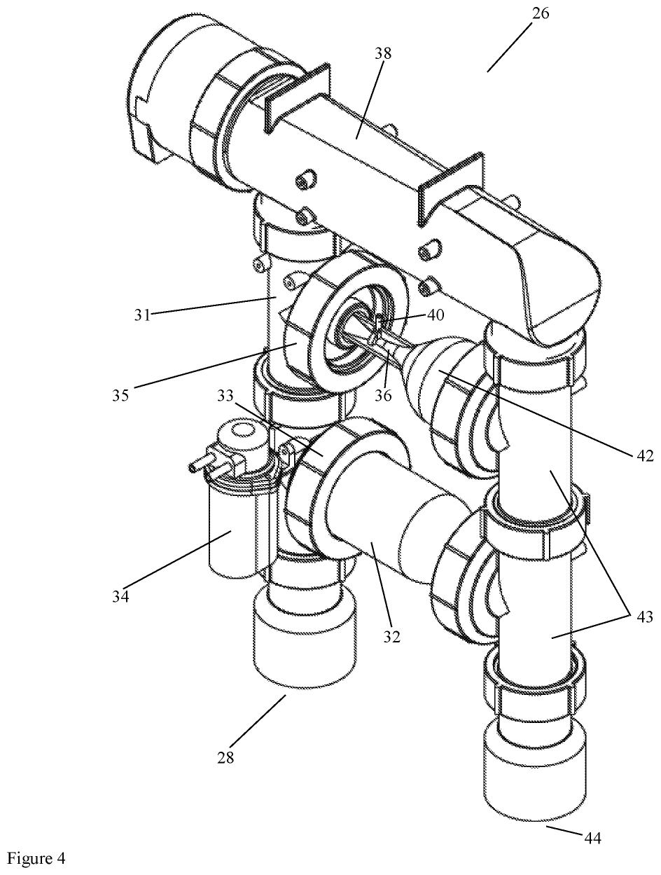

In FIG. 3, there is shown a top left perspective view of a delivery system 26 according to an alternative embodiment of the invention. The delivery system 26 has a water inlet 28 through which a portion of a body of water for treating enters the system 26. The water passes from the inlet 28 through a set of stacked manifolds 30 and 31. Manifold 30 is associated with a flow splitter 33, which enables some of the portion of water to pass to a probe (not shown) within a probe housing 32, and some of the portion of water to continue to manifold 31. The probe housing 32 is associated with a peristaltic pump 34.

Manifold 31 is associated with a flow splitter 35, which enables the bulk of the remaining portion of water to pass to a venturi 36 and some of the remaining portion of water to continue to an electrolyser 38.

The venturi 36 is provided with an ozone inlet port 40, through which ozone from an ozonator (not shown) is introduced to the venturi 36, and thus the portion of water that is passing through the venturi 36.

After passage through the venturi 36, the ozonated water enters a stagnation chamber 42 at the outlet of the venturi 36. In this embodiment, the stagnation chamber 42 is an integral part of the venturi 36. The ozonated water then passes from the stagnation chamber 42 through manifolds 43 before exiting the delivery system 26 through a water outlet 44 into the main body of water.

In FIG. 4, a top right perspective view of the delivery system of FIG. 3 is shown, with like features numbered similarly.

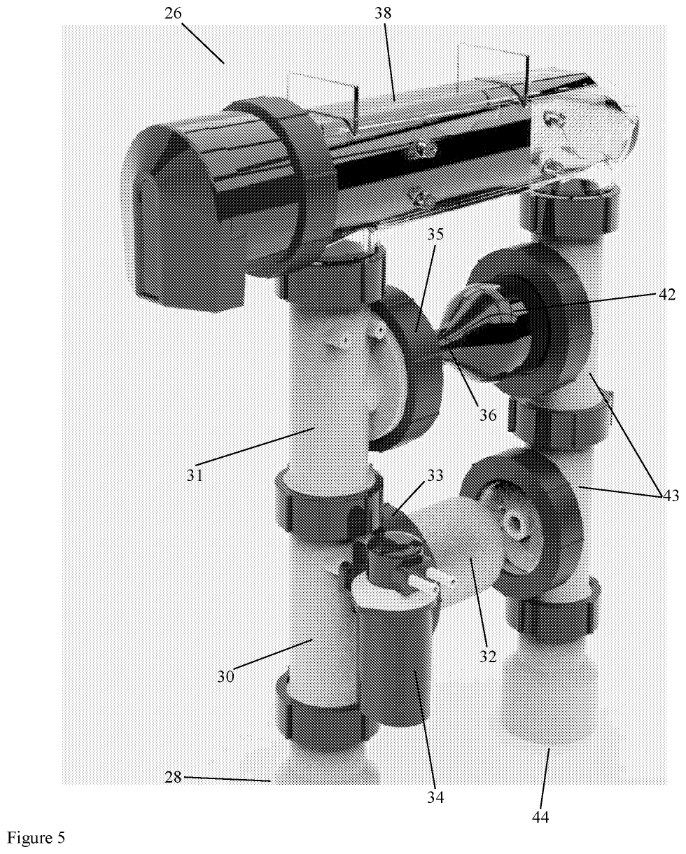

Similarly, in FIG. 5, a front left perspective view of the delivery system of FIG. 3 is shown, with like features numbered similarly.

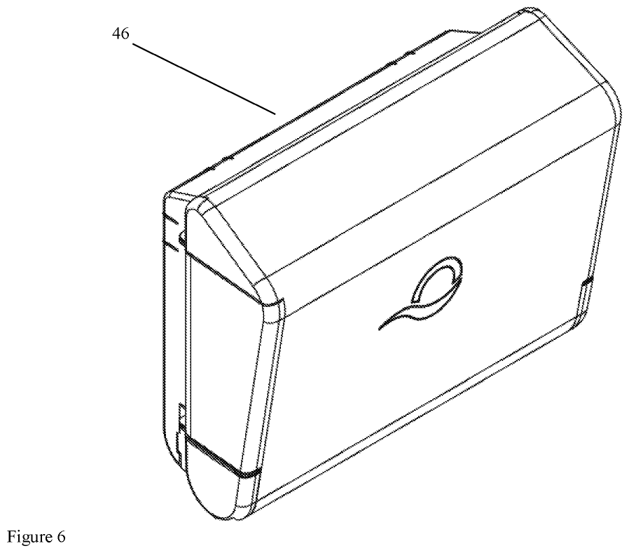

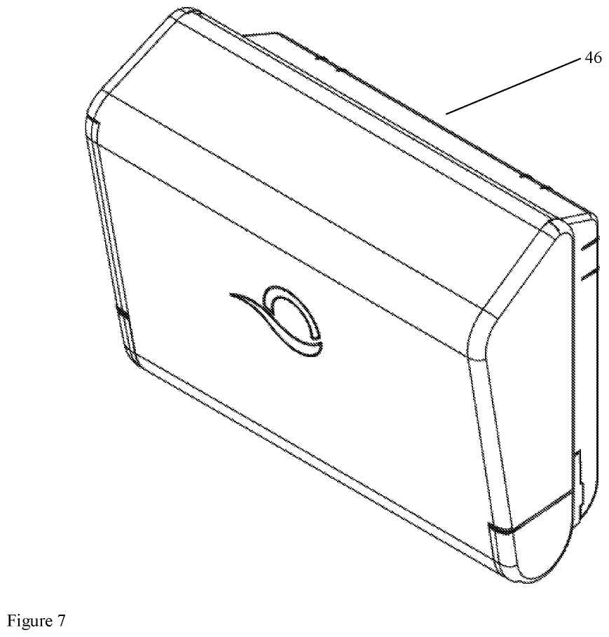

In FIG. 6, there is shown a top left perspective view of a control box 46 according to an embodiment of the invention, whilst is FIG. 7, there is shown a top right perspective view of the embodiment of the control box 46 of FIG. 6. The control box 46 is essentially a system housing and contains a mains rated powerpack with appropriate power and connection requirements.

For example, the control box 46 can be configured to provide an output from 250-600 volt-ampere (VA) from 50 or 60 Hz, 110-130 volts AC or 220-240 volts AC. Preferably, the control box 46 is configured to provide an output of 250 VA, 400 VA, or 600 VA from 50 or 60 Hz, 110-130 volts AC or 220-240 volts AC. Irrespective of the output, an electronic identification dongle can detect the output power and automatically configure the electrolyser.

Additionally, the control box 46 can be fitted with SAA, EURO or NEMA power supply leads and outlet sockets appropriate to the installation region.

The control box 46 provides locations for user serviceable controllers for one or more of (i) a chlorinator module; (ii) a central processing unit (CPU); (iii) user interface module; (iv) an instrument module; (v) a ozone corona discharge module; and (vi) a universal module.

Where present, the chlorinator module is interfaced to a chlorination cell. The chlorination cell is preferably configured for chlorination of a body of water ranging from 20,000 L up to 160,000 L.

In the embodiment of the invention as shown in FIGS. 1 and 2, the venturi 16 is controlled by an ozone corona discharge module in the control box 46. Similarly, in the embodiment of the invention as shown in FIGS. 3 and 4, the venturi 36 is controlled by an ozone corona discharge module in the control box 46.

In the embodiment of the invention as shown in FIGS. 3-5, the probe housing 32 is associated with a peristaltic pump 34 which is controlled by an instrument module in the control box 46.

The delivery system as shown in FIGS. 3-5 is a modular system and can be expanded by the addition, for example, of another manifold, probe housing and peristaltic pump combination. For example one probe housing can accommodate a pH probe, while a second probe housing can accommodate a temperature probe. Each probe housing and peristaltic pump combination is controlled by a separate instrument module in the control box 46.

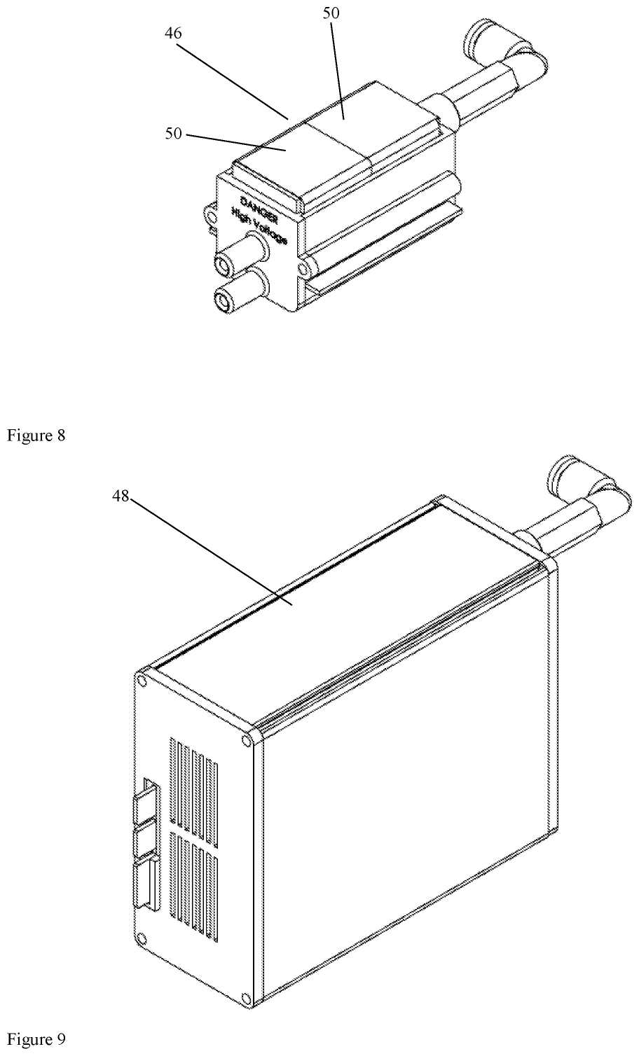

In FIG. 8, there is shown a perspective view of an ozone corona discharge encapsulation assembly 46 as part of an embodiment of the invention, whilst in FIG. 9, there is a perspective view of an outer case 48 for the ozone corona discharge encapsulation assembly 46 of FIG. 8.

The ozone corona discharge module encapsulation assembly 46 comprises a flyback transformer that generates a high voltage on the flyback cycle. In contrast to flyback transformers of the prior art, the present discharge module utilises a pulsed circuit and measures the period between maximum current flows. Based on the measured frequency, the software controlling the ozone corona discharge module can increase output without causing waste heat or overloading the circuit. That is, the flyback transformer of the present invention can adjust the frequency of the ozone corona discharge module to reach optimal output without expending energy pushing against a flyback in a module with a low frequency.

The encapsulation assembly preferably comprises a polymer blend 50 to seal the module. In a particularly preferred embodiment, the polymer blend comprises santoprene. Advantageously, the corona discharge module encapsulation assembly prevents release of tramp ozone. Tramp ozone is ozone that is produced outside of the dielectric barrier and contaminates the inside circuitry.

In a further advantage, the outer case 48 of the corona discharge encapsulation assembly effectively provides a heat transfer mechanism, moving heat from the anode to the housing. In a preferred embodiment, the outer case 48 is aluminium.

Finally, the outer case 48 seals the ozone stream inside, preventing egress of ozone.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A system for delivery of one or more products to a body of water for treating and/or disinfecting the body of water, the system comprising:
(i) a water inlet;
(ii) an ozonator comprising an air inlet with an oxygen separator membrane attached to the air inlet, wherein the oxygen separator member prevents passage of some nitrogen into the ozonator and is therefore a nitrogen filter;
(iii) a venturi, wherein the venturi is associated with a chamber at the outlet of the venturi, and where the diameter of the outlet of the venturi is substantially larger than the diameter of the inlet of the venturi;
(iv) an electrolyser; and
(v) a water outlet,
wherein the ozonator is in gaseous communication with the venturi, such that ozone generated in the ozonator is introduced into water as the water passes into the venturi,
wherein a stream of water simultaneously passes through the electrolyser,
wherein the static pressure of the water in the chamber at the outlet of the venturi is high, leading to an increase in the solubility of ozone in the water; and
wherein the resultant ozonated water and electrolyzed water combine to form a single stream that exits the system via the water outlet.

2. (canceled)

3. The system of claim 1, wherein a pressure drop at the inlet to the venturi is followed by an increase in static pressure towards the exit outlet of the venturi, with a concomitant reduction in the velocity of the water in the chamber at the outlet of the venturi compared to the velocity of the water at the inlet to the venturi.

4. The system of claim 1, wherein the outlet of the venturi has internal radial vanes.

5. The system of claim 1, wherein the ozonator is a corona discharge ozonator.

6. The system of claim 1, further comprising one or more probes in fluid communication with water from the inlet.

7. The system of claim 6, wherein the one or more probes are selected from a pH probe and a temperature probe.

8. The system of claim 6, wherein the probes, venturi and electrolyser are in a modular arrangement, such that water from the inlet simultaneously passes to the probes, venturi and electrolyser.

9. (canceled)

10. (canceled)

11. A method of treating and/or disinfecting a body of water, the method comprising passing a portion of the water through a system, the system comprising:
(i) a water inlet;
(ii) an ozonator comprising an air inlet with an oxygen separator membrane attached to the air inlet, wherein the oxygen separator member prevents passage of some nitrogen into the ozonator and is therefore a nitrogen filter;
(iii) a venturi, wherein the venturi is associated with a chamber at the outlet of the venturi, and where the diameter of the outlet of the venturi is substantially larger than the diameter of the inlet of the venturi; and
(iv) a water outlet,
wherein the ozonator is in gaseous communication with the venturi, such that the portion of water enters the system via the water inlet and passes through the venturi, while ozone generated in the ozonator is introduced into the water as the water passes into the venturi, wherein the static pressure of the water in the chamber at the outlet of the venturi is high, leading to an increase in the solubility of ozone in the water, resulting in ozonated water which exits the system via the water outlet.

12. (canceled)

13. (canceled)

14. (canceled)
